(19) United States
(12) Patent Application Publication
(10) Pub. No.: US 2025/0271324 A1
(43) Pub. Date: Aug. 28, 2025

(54) GAS LINE AND METER PRESSURE TESTING TOOLS AND METHODS

(71) Applicant: STH Tools, Ltd., Ney, OH (US)

(72) Inventors: Jeffrey Lee MCCOY, Ney, OH (US); Erik Dean BROWN, Montpelier, OH (US)

(21) Appl. No.: 19/066,518

(22) Filed: Feb. 28, 2025

Related U.S. Application Data
(60) Provisional application No. 63/558,671, filed on Feb. 28, 2024.

(51) Int. Cl. G01M 3/28; F17D 5/00; F17D 5/02

(52) U.S. Cl. CPC G01M 3/2815; F17D 5/005; F17D 5/02

(57) ABSTRACT

The present invention involves a pressure testing tool for quick and efficient installation of gas service. The tool is a monolithically integrally formed chamber having an inflation portal, a rotatable connection portal with a plurality of internal and external threaded connection portions, and a rotatable meter section. With this single tool, the system may be attached, pressurized, and pressure monitored at the appropriate pressure with greater efficiency than prior combinations.

### CROSS-REFERENCE TO RELATED APPLICATIONS

The present application is an original United States Patent Application which claims priority under 35 U.S.C 35 U.S.C. § 119 (e) of Provisional Patent Application Ser. No. 63/558,671, filed Feb. 28, 2024, the disclosures of which are incorporated by reference herein.

### FIELD

The claimed technology relates generally to testing equipment and more particularly to equipment and procedures for pressure testing natural gas lines and fittings.

### BACKGROUND

Each time natural gas is turned off, for example as shown in FIG. 1 at a gas meter 20, a pressure test of the fuel line must be performed before the gas can be turned back on. The pressure test consists of checking the fuel line from outlet swivel 24 of the meter set to the control valves of the appliances inside the building. Local gas company requirements typically specify for pressurizing the system at 10″ water column for 5 minutes. If the needle on the pressure gauge does not move within 5 minutes, the pressure test passes. If the needle does move within that time frame, that reveals a leak in the system. After repairs are made to the system, the gauge is again used to determine whether or not the leak has been fixed.

For a newly constructed building or installation of new piping in an existing structure, two pressure tests are required. The first is at 3 psi (pounds per square inch) for 5 minutes with stops off to appliances. This test is completed with a pounds gauge. If this test holds, pressure is released from the system and the pounds gauge is unscrewed from the test rig. An inches gauge replaces the pounds gauge, the stops are opened to the appliances and the system is then tested to the 10″ water column as described previously.

Every time a pressure test is performed, inlet side 22 of meter set 20 is also checked for flow rate and lock up on the regulator. The flow rate measures the rate at which gas is flowing through the testing rig. This is generally required to be at 5½″ water column. The lock up measures the pressure when the gas is not flowing through the testing rig. This is generally required to be 6 inches water column.

One example of the complicated testing procedure of the prior art involves, for example, 25 steps. To test a meter on an industrial meter set, the current procedure is: (1) Shut off the gas; (2) Use two (2), 24″ pipe wrenches to loosen the unions on the 2″ pipe on both the inlet and outlet sides of meter set. It takes two (2) people to hold both sides of the meter set; (3) Remove the meter; (4) Remove union from pipe nipple on the outlet side of the meter set; (5) Teflon tape and pipe dope threads on the 2″ nipple on the outlet side of the meter set; (6) Screw on a 2″×¾″ coupling to the 2″ nipple on the outlet side; (7) Apply pipe dope to both ends of a ¾″×2″ nipple; (8) Screw on a ¾″×¾″×¾″ tee to the nipple and screw both together into the ¾″ end of the ¾″×2″ coupling; (9) Apply pipe dope to both ends of a second ¾″×2″ nipple: (10.) Screw a ¾″ ball valve into the ¾″×2″ nipple; (11) Screw ball valve and nipple into ¾″ tee; (12) Apply pipe dope to a/4″×¼″ bushing and screw into the end of the ¾″ tee; (13) Apply pipe dope to threads of a Schrader valve and screw into ¼″ bushing; (14) The assembled test rig is then used in conjunction with the local regulations for the system being tested; (15) The Compliance Manual determines the type of measuring tool (i.e. gauge or chart box) to be utilized and the pressure at which the system is to be tested based on the size of pipe and length of the system; (16) If using a gauge to measure pressure: (a) Apply pipe dope to threads on a ¾″×¼″ bushing and screw into top of tee, or (b) Apply pipe dope to threads of the gauge and screw into ¾″×¼″ bushing; (17) If using a chart box to measure pressure: (a) Apply pipe dope to threads on a ⅜″ flare and screw into top of tee, or (b) Screw chart box base into the flare fitting; (18) Use a pressure tank, air compressor or bicycle pump to pressurize system at the Schrader valve; (19) Pressurize the system to the specifications required in the Compliance Manual; (20) Once the test has been successfully completed, release the pressure and remove all pieces added to 2″ nipple on outlet side; (21.) Teflon tape and pipe dope threads on 2″ nipple on outlet side and reattach union; (22) Two (2) people pick up the meter and reattach the unions; (23) Restore gas to service; (24) Clean all pieces used for test and return to the tool box; and (25) This procedure takes a minimum of 50 minutes to complete, 100 minutes total using 2 people working together.

Another example of a current 10″ water column (w/c) test using a 30 lite 1¼″ swivel on existing commercial and light industrial structures involves the steps of: (1) Shut off the gas and remove the meter; (2) Take a pipe wrench and remove the 30 lite swivel from the elbow above the outlet side of the meter; (3) A 1¼″ nipple is used in place of the 30 lite swivel, resulting in teflon tape being applied to the pipe threads on both ends of the nipple, with pipe dope applied over the tape; (4) Screw a 1¼″ to ¾″ coupling to the 1¼″ nipple; (5) Screw the 1¼″ nipple and 1¼″ to ¾″ coupling into the elbow above the outlet side of meter, replacing the 30 lite swivel and tighten; (6) Apply pipe dope to one end of a ¾″×2″ nipple and screw on a 1-A swivel; (7) Apply pipe dope to the other end of the nipple and screw into the ¾″ end of the coupling; (8) When 1¼″ nipple, 1¼″×¾″ coupling and 1-A swivel are tight, screw the 1-A swivel into the Gas Company test rig and tighten; (9) Use hand pump and pressurize the system to 10″ water column (w/c); (10) Current Gas Company regulations require the 10″ w/c must hold steady for the specified time period based on pipe dimensions [If the needle does move, it indicates a leak that must be located and fixed before proceeding]; (11) If the needle on the test rig's gauge does not move in the required time period, the pressure test passes; (12) Once the pressure test has been successfully completed, unscrew the 1-A swivel from the test rig; (13) Remove the 1¼″ nipple, 1¼″×¾″ coupling and 1-A swivel from the elbow above the outlet side of the meter; (14) Apply Teflon tape and pipe dope to the threads of the 1¼″ swivel and screw into the elbow above the outlet side of the meter and tighten; (15) To test the flow and lock-up of the regulator: (a) Take a pipe wrench and remove the 30 lite swivel from the elbow above the inlet side of the meter, (b) A 1¼″ nipple is used in place of the 30 lite swivel, with teflon tape being applied to the pipe threads on both ends of the nipple, with pipe dope applied over the tape, (c) Screw a 1¼″ to ¾″ coupling to the 1¼″ nipple, (d) Screw the 1¼″ nipple and 1¼″ to ¾″ coupling into the elbow above the outlet side of meter, replacing the 30 lite swivel and tighten, (e) Apply pipe dope to one end of a ¾″×2″ nipple and screw on a 1-A swivel, (f) Apply pipe dope to the other end of the nipple and screw into the ¾″ end of the coupling, (g) When 1¼″ nipple, 1¼″×¾″ coupling and 1-A swivel are tight, screw the 1-A swivel into the Gas Company test rig and tighten, (h) Remove the ball hand pump and open the stop, which allows gas to flow through the test rig, (i) With gas running, the pressure is monitored to determine if it is flowing at 5½″ w/c., (j) If this standard is not met, the regulator is adjusted, (k) Once the 5½″ w/c flow rate is achieved, the stop on the test rig is shut, (1) Monitor the gauge for lock-up which is the pressure when the gas is not flowing. The gauge should show 6″ w/c., (m) If the flow and lock up of the regulator are acceptable, the gas is turned off, (n) Unscrew the 1-A swivel from the test rig, (o) Remove the 1¼″ nipple, 1¼″×¾″ coupling and the 1-A swivel from the elbow above the inlet side of the meter, and (p) Apply Teflon tape and pipe dope to the threads of the 1¼″ swivel and screw into the elbow above the inlet side of the meter and tighten; (16) Reattach the meter loosely on the outlet side; (17) Verify that the meter is clocking which means the dials are turning to signify gas is flowing through and being measured; (18) Tighten the swivels on both sides of the meter; (19) Clean pipe dope and Teflon tape off the 1¼″ nipple, 1¼″×¾″ coupling, ¾″×2″ nipple and 1-A swivel and return them to the tool box; and (20) This procedure takes a minimum of 45 minutes to complete.

These testing procedures typically require several steps before they can be performed. Thread lubricant and/or sealing compound must be applied to all threaded connections and gauges must be physically screwed into and out of connections. For applications using larger supply lines it is common for technicians to have to assemble a testing rig using spare parts on site to accommodate standard size gauges. Large supply lines may also require greater volumes of air to achieve the required pressures which may require an on-site compressor or air tank. There remains a need for improved testing tools and procedures for testing natural gas piping.

### SUMMARY

The innovations of the invention involve a streamlined tool and process for more efficiently addressing the constraints of pressure testing by providing a pressure testing tool that has a body allowing for rotation of pressure gauges and swivel threads for air-tight connections to the piping. Embodiments of the invention provide quick connect fittings for the pressure gauges. This eliminates pipe dope and physically screwing the gauges in and out of the inventive test rig, the “hex rig”. The design allows the pressure gauges to rotate up to 360 degrees for an easy read in any position. The inventive tool also contains a Schrader valve for testing bigger fuel lines that require a larger volume of air, which is generally provided by an air tank or air compressor. Currently utilized tests rigs would not accommodate these larger fuel lines, and technicians have to construct something on site to perform the mandated pressure tests on these lines. The tool includes 1-A swivel threads welded to the body, and is threaded inside the 1-A to accept different size swivel adapters and a pipe adapter. Adapters have O-rings that provide an air-tight seal when screwed into the 1-A swivel.

Embodiments of the inventive kit are packaged in a plastic tool box with a formed styrofoam bottom that holds the tool's body, gauges, adapters and related components. The tool box contains everything that is needed to test any size meter or pipe. Current testing tools are built using many different parts to assemble whatever is needed to perform the required pressure test.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a front view of a typical prior art natural gas meter set.

FIG. 2 is an example of a technician-assembled pressure testing unit according to the prior art.

FIG. 3 is a pressure testing tool according to one example of the disclosed technology.

FIG. 4 is an example of the components used in a pressure testing unit according to the prior art.

FIG. 5 is the assembled prior art pressure testing unit of FIG. 4.

FIG. 6 is another example of a pressure testing tool according to the disclosed technology.

FIG. 7 is a fully assembled example of the pressure testing tool of FIG. 6.

FIG. 8 is still another example of a pressure testing tool according to the disclosed technology.

FIG. 9 is a perspective view of the pressure testing tool of FIG. 8.

FIG. 10 is an example of a pressure testing unit according to the prior art.

FIG. 11 is yet another example of a pressure testing tool according to the disclosed technology.

FIG. 12 is another view of the pressure testing tool of FIG. 11.

FIG. 13 is an example of a pressure testing unit according to the prior art.

FIG. 14 is a pressure testing tool kit according to one example of the disclosed technology.

FIG. 15 is a blueprint sectional view of the monolithically integrated tool body of one embodiment of the present invention.

FIGS. 16 and 17 are views of a further embodiment without and with a hand pump, respectively.

FIG. 18 is a view of an alternative embodiment of the hex rig component of several embodiments of the present invention.

FIG. 19 is an exploded view of the connection of the hex rig and monolithically integrated tool body of one embodiment of the present invention.

FIG. 20 is the assembled view of FIG. 19.

FIGS. 21 and 22 are views of alternative embodiments of gauges which may be used with the monolithically integrated tool body of the present invention.

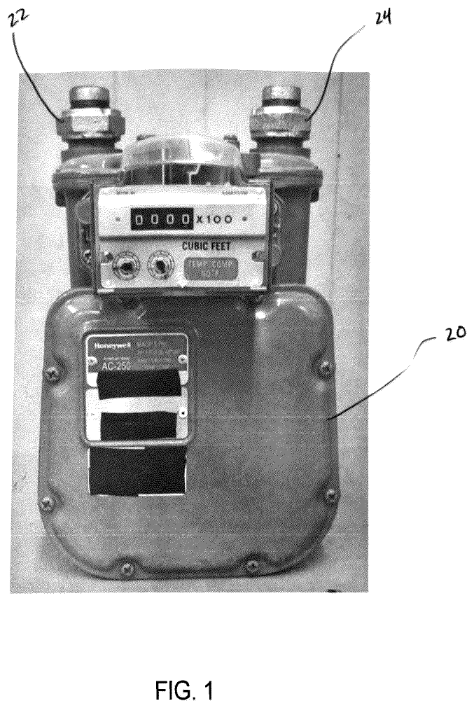

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

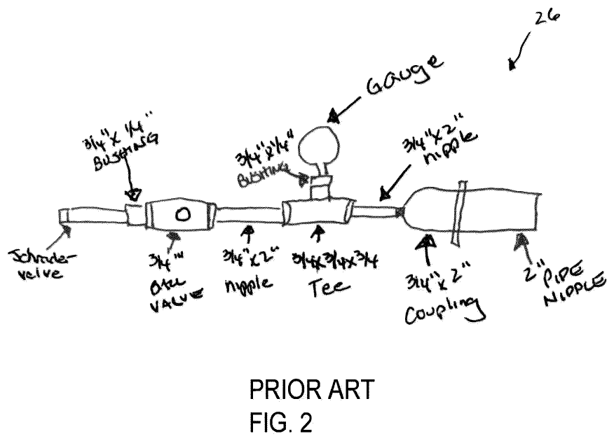

An example of a technician-assembled testing device 26 is shown in FIG. 2. Such devices are commonly assembled using parts commonly found in a parts bin or work truck used by gas line installers and maintenance crews to perform one or more of the testing procedures previously described. A Schrader valve may need to be utilized instead of a hand pump to allow for a larger volume of air to be injected into the line because a hand pump would require a great deal of extra time to fill these larger pipes. This procedure is used to build test rigs when testing standard pipe threads of any size diameter pipe.

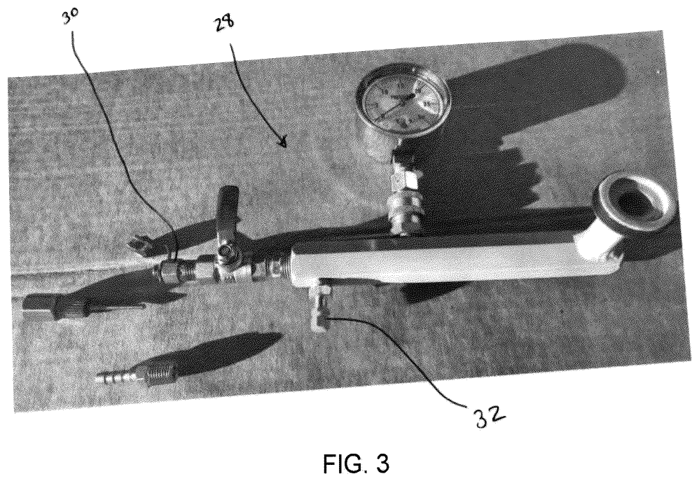

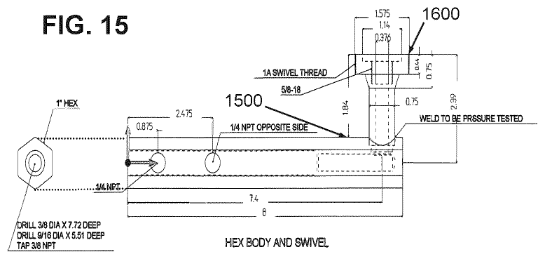

One example of pressure testing tool 28 according the disclosed technology is shown in FIG. 3, a monolithically integrated tool. This particular example is configured for pressure testing tool 28 to perform on fuel lines in systems that have gas meters without swivels. The meters may have unions that attach to the meter. Optionally, Schrader valve 32 may be utilized instead of a hand pump to allow for a larger volume of air to be injected into the line because a hand pump would require a great deal of extra time to fill these larger pipes. Measuring device attachment point 30 allows for various pressure testing gauges or devices to be quickly attached and removed to tool 28 as local codes may require using different measuring devices to perform certain tests. This procedure is used when utilizing tool 28 to test standard pipe threads of any size diameter pipe. Tool 28 pipe adapter may be paired with any size coupling or bushing to accommodate the desired size. In the present specification the phrase “monolithically integrated” is used to describe items that are fashioned together from one piece of material; this to be contrasted with a situation where the items are joined together after manufacture, either detachably or through a non-integral coupling. In this particular example a single piece of material, for example a metal, has a single piece of material that allows fluid communication between an inflation portal (for pressurizing an attached system), a meter portion (for attaching to an appropriate meter), and a connection portion (for coupling with the system being tested). The central portion of the tool may, for example, be molded, cast, machined or otherwise fashioned from one monolithic piece of material and the portals and portions are fashioned, formed or made from the same monolithic piece of material. Each component of the tool may be formed during the same process as that within which the others are made, or alternatively each may be separately fashioned in a separate process to create the monolithically integrated tool. FIG. 15 provides one embodiment of the monolithically integrated body of tool 28, and is shown as integral body 1500 with adapter 1600.

One example method of using pressure testing tool 28 to perform a pressure test on a 2 inch gas line includes the steps of: (1) Shut off the gas; (2) Use two (2), 24″ pipe wrenches to loosen the unions on the 2″ pipe on both the inlet and outlet sides of meter set [it takes two (2) people to hold both sides of the meter set]; (3) Remove the meter; (4) Remove union from pipe nipple on the outlet side of the meter set; (5) Teflon tape and pipe dope threads on the 2″ nipple on the outlet side of the meter set; (6) Screw on a 2″×½″ coupling to the 2″ nipple on the outlet side; (7) Apply pipe dope to the threads of ½′ pressure testing tool pipe adapter; (8) Screw into the ½″ end of the coupling; (9) Screw pressure testing tool to its pipe adapter with a crescent wrench [The O-ring in the adapter requires only a quarter turn to “snug up” the connection]; (10) The local regulations determine the type of measuring tool (i.e. gauge or chart box) to be utilized and the pressure at which the system is to be tested based on the size of pipe and length of the system; (11) If using a gauge to measure pressure attach gauge to pressure testing tool using the quick connect fitting; (12) If using a chart box to measure pressure, remove the hand pump and hose barb, replacing with a Pete's plug and attaching the chart box; (13) Using a pressure tank, air compressor or bicycle pump to pressurize the system at Schrader valve, which is a standard component of the pressure testing tool; (14) Pressurize the system to the specifications required in the local regulations; (15) Once the test has been successfully completed, release the pressure and remove pressure testing tool and adapter and ½″×2″ coupling; and (16) Teflon tape and pipe dope threads on 2″ nipple on outlet side and reattach union; (17) Two (2) people will pick up the meter and reattach the unions; and (18) Restore gas to service; (19) Clean ½″ pipe adapter and return it and the pressure tool adapter to the tool box; (20) This procedure takes a minimum of 30 total minutes to complete, 60 minutes total, using 2 people working together.

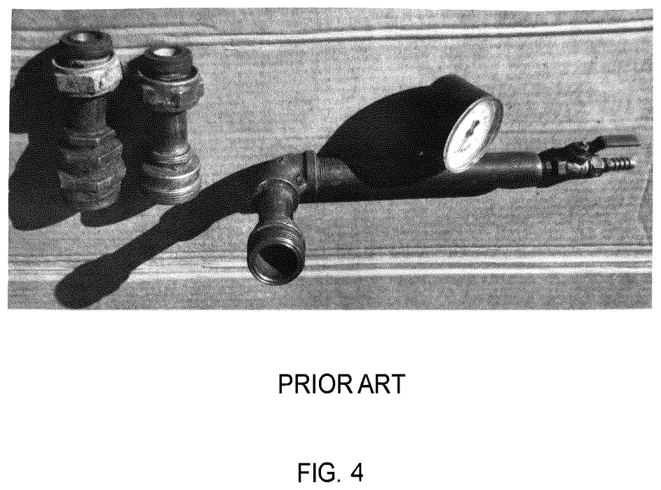

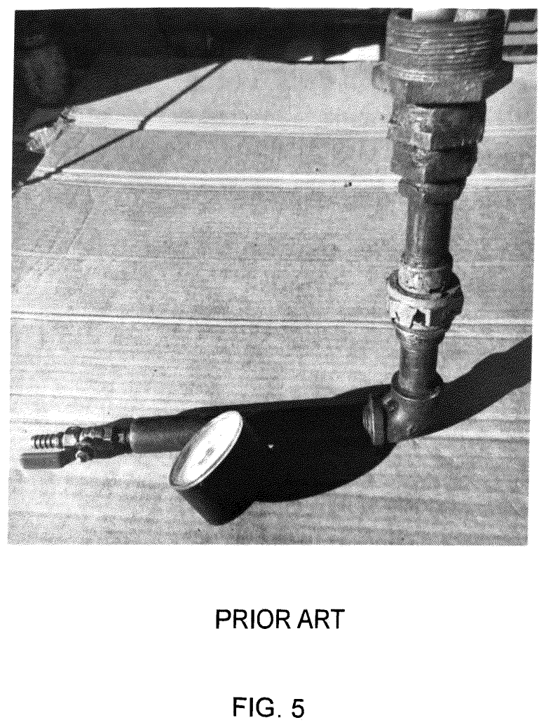

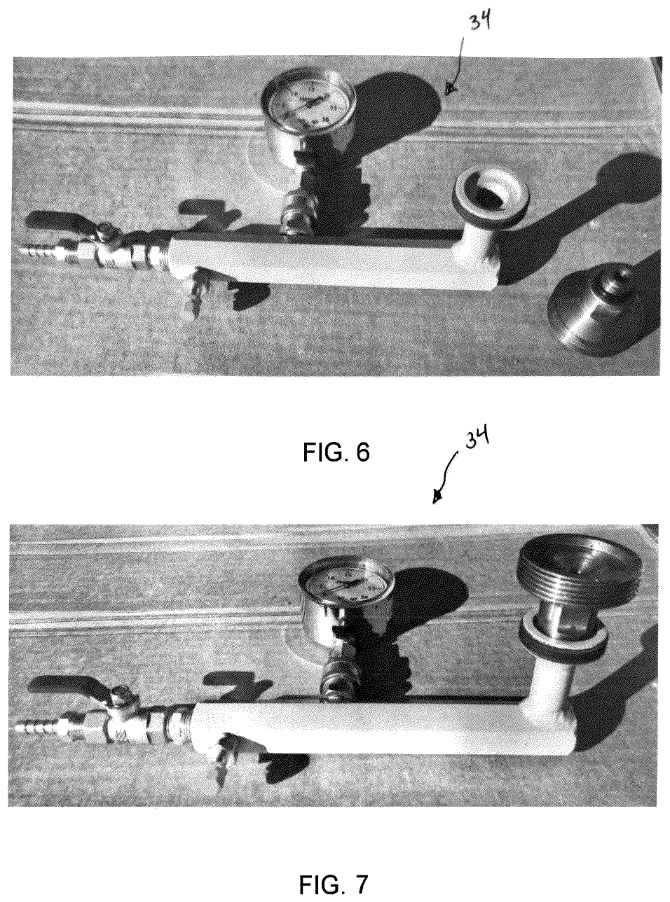

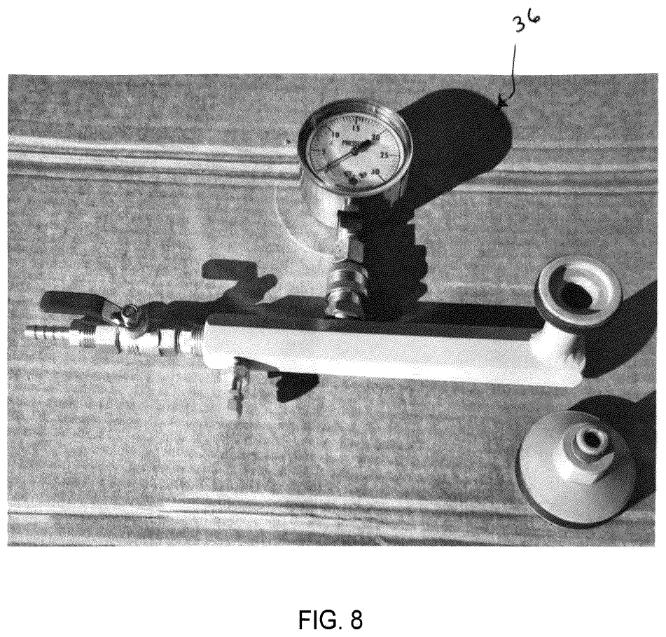

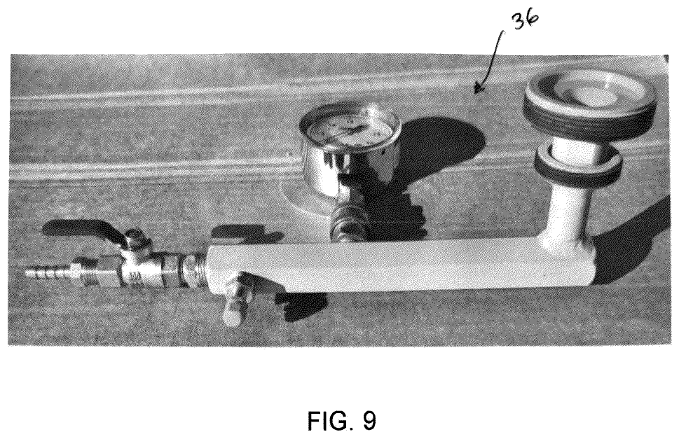

Water column pressure tests are typically currently performed using assemblies such as those shown in FIGS. 4-5 on both 30 lite and 45 lite swivel meter sets which consist of a meter and a regulator. Such configurations are commonly found in both residential and light commercial settings (30 lite) and in commercial and light industrial settings (45 lite). Pressure testing tool 34 suitable for performing pressure testing on a 30 lite configuration is shown both disassembled (FIG. 6) and assembled (FIG. 7). Pressure testing tool 36 suitable for performing pressure testing on a 45 lite configuration is shown both disassembled (FIG. 8) and assembled (FIG. 9). One example of a testing procedure using pressure testing tool 34 or 36 may include the steps of: (1) Shutting off the gas and removing the meter; (2) Attaching either the 30 or 45 lite adapter to testing tool 34 [an optional additional o-ring may be used in combination with any seal in the adapter to secure the connection]; (3) Screw the 30 or 45 lite swivel into the 30 or 45 lite adapter and tighten on the outlet side of meter; (4) Use hand pump and pressurize the system to 10″ water column (w/c); (5) Close the stop; (6) Local regulations typically require the 10″ w/c to hold steady for the specified time period based on pipe dimensions; (7) If the needle on test tool 34 gauge does not move in the required time period, the pressure test passes, otherwise if the needle does move it indicates a leak that must be located and fixed before proceeding; (8) Once the pressure test has been successfully completed, unscrew the outlet swivel from the adapter on test tool 34; (9) To test the flow and lock-up of the regulator: (a) Screw inlet swivel to adapter on test tool 34 and tighten, (b) Remove the ball hand pump and open the stop, which allows gas to flow through test tool 34, (c) With gas running. pressure is monitored to determine if it is flowing at 5½″ w/c, (d) If this standard is not met, the regulator is adjusted, (e) Once the 5½″ w/c flow rate is achieved the stop on test tool 34 is shut, (f) Monitor the gauge for lock-up which is the pressure when the gas is not flowing, with the gauge hopefully showing 6″ w/c, (g)

If the flow and lock up of the regulator are acceptable, the gas is turned off, (h) Unscrew the inlet swivel from the adapter on test tool 34, and (i) Attach meter to the inlet side; (10) Remove the test tool 34, (11) Reattach the meter loosely on the outlet side; (12) Verify that the meter is clocking wherein the dials are running to signify gas is flowing through and being measured; and (13) Tighten the swivels on both sides of the meter.

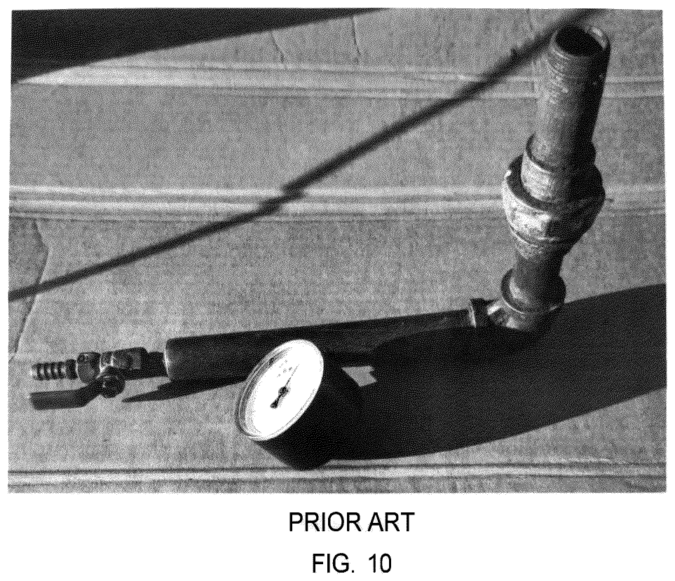

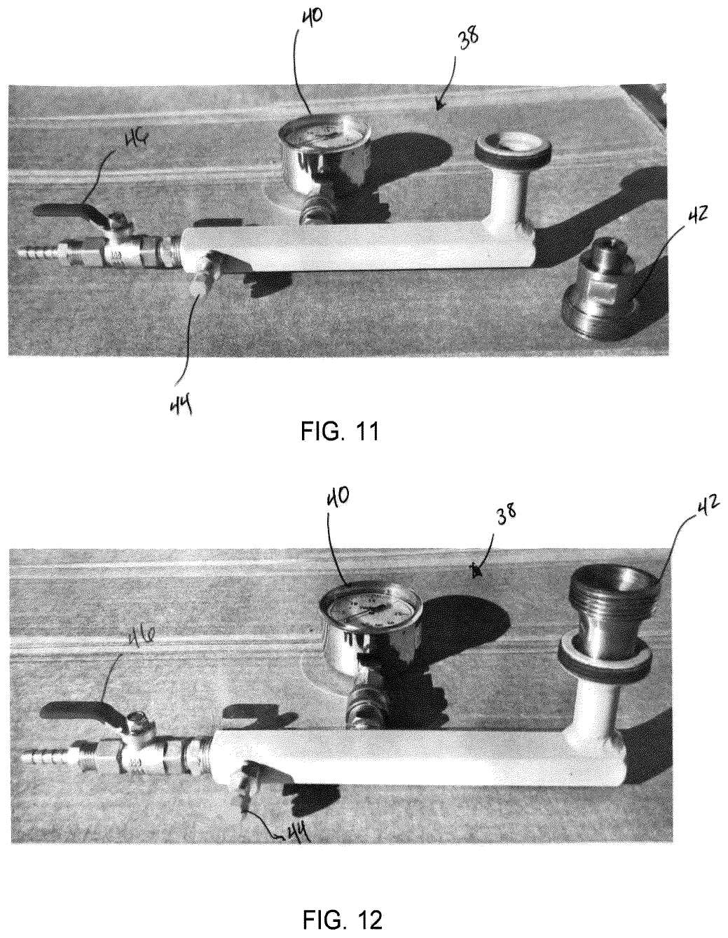

Water column pressure tests are typically currently performed using prior art assemblies such as those shown in FIG. 10 on 10 lite swivel meter sets which consist of a meter and a regulator. Such configurations are commonly found in residential settings. A pressure testing tool 38 suitable for performing pressure testing on a 10 lite configuration is shown both disassembled (FIG. 11) and assembled (FIG. 12). One example of a testing procedure using the disclosed pressure testing tool 38 may include the steps of: (1) Shut off the gas and remove meter; (2) Screw 10 lite adapter into test tool 38 [an optional additional o-ring in addition to any seal in the adapter seals the connection]; (3) Screw 10 lite swivel to the 10 lite adapter 42 on test tool 38 and tighten on outlet side of meter set; (4) Use hand pump and pressurize the system using the hose barb to 10″ w/c and close the stop; (5) Local regulations require the 10″ w/c to hold steady for a specified time (e.g, 5 minutes); (6) If the needle on test tool 38 gauge 40 does not move in the required time, the pressure test passes, but if the needle does move, it indicates a leak that must be located and fixed before proceeding; (7) Once the pressure test has been successfully completed, unscrew the outlet swivel from test tool 38 adapter; (8) Attach meter to the inlet swivel; (9) To test the flow and lock-up of the regulator: (a) Using a nipple with a 10 lite swivel attached to both ends, screw one end to the outlet side of the meter, (b) Attach the test tool 38 into the opposite end of the nipple with swivels and tighten, (c) When the test tool 38 is upside down, turn the pressure gauge 40 so it can be seen [gauge 40 is able to rotate up to 360 degrees using hands only, i.e., toolless adjustment], (d) Remove the ball hand pump and open the stop, which allows gas to flow though the test tool 38, (e) With gas running the pressure is monitored to determine if it is flowing at 5½″w/c, (f) If this standard is not met, the regulator is adjusted, (g) Once the 5½″ w/c flow rate is achieved, close stop 46 on test tool 38, (h) Monitor gauge 40 for lock-up which is the pressure when the gas is not flowing, with gauge 40 showing 6″ w/c, and (i) If the flow and lock up of the meter are acceptable, the gas is turned off; (10) Remove test tool 38; (11) Reattach the meter loosely on the outlet side; (12) Verify that the meter is clocking [the dials are turning to signify gas is flowing through and being measured]; and (13) Tighten the swivels on both sides of the meter.

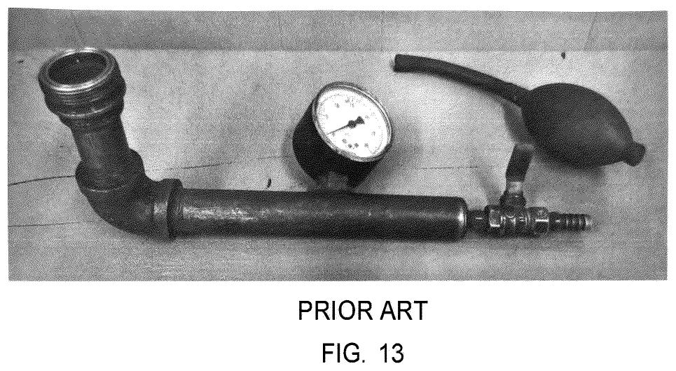

The pressure test for a natural gas system in a newly constructed building or when new pipe has been installed in an existing facility is typically a 3 pound (lb.) test followed by a 10″ water column (w/c) test using a 1-A swivel meter set. Because the new pipe has not had gas in it before the additional 3 lb. test is commonly performed. The prior art testing rig used for such procedures is shown in FIG. 13. The pressure test tools 28, 34, 36, 38 previously shown and described may be used to perform such testing procedures. One example of a 10 inch water column test performed on new construction and/or newly installed piping using an 1-A swivel with pressure test tools 28, 34, 36, 38 may include the following steps: (1) Shut off the gas; (2) Unscrew the 1-A swivel from both sides (inlet and outlet) of the meter, remove and set meter aside; (3) Attach the pounds gauge to pressure testing tool, using the quick connect fitting; (4) When testing new pipe, the stops to all appliances must be shut off so the system can be tested at 3 pounds (lbs) psi; (5) Attach the outlet swivel of the meter to the pressure testing tool and tighten; (6) Turn the pounds gauge until it can be easily read, with the gauge being able to rotate up to 360 degrees using hands only; (7) Use the hand pump to pressurize the system to 3 pounds (lbs); (8) Turn the stop on the pressure testing tool to “Off” when the pressure reaches 3 lbs psi; (9) Local regulations typically require that the 3 lbs. psi must hold for 10 minutes; (10) If the needle on the pressure testing tool's measuring device does not move in the required 10 minutes, the pressure test passes. If the needle does move, it indicates a leak that must be located and fixed before proceeding; (11) Once the pressure test has been successfully completed, release the pressure from the system and open the stops to all the appliances; (12) Remove the pounds gauge from the pressure testing tool and attach the inches gauge, using the quick connect fitting, the gauge may be rotated until it can be easily read; (13) Pressurize the system by using the hand pump to reach 10″ water column (w/c); (14) Move the pressure testing tool's stop to the “Off” position to lock the pressure at 10″ w/c; (15) Local regulations typically require the 10″ w/c must hold steady for 5 minutes; (16) If the needle on the pressure testing tool gauge does not move in the required 5 minutes, the pressure test passes, but the needle not moving indicates a leak that must be located and fixed before proceeding; (17) Once the pressure test has been successfully completed, the pressure testing tool is removed from outlet side of the meter set; (18) Attach meter to inlet swivel; (19) To test the flow and lock-up of the regulator: (k) Using a nipple with a 1-A swivel attached to both ends, screw one end to the outlet side of the meter, (1) Attach the pressure testing tool into the opposite end of the nipple with swivels and tighten, (m) When the rig is upside down, rotate the pressure gauge so it can be seen, (n) The gas is slowly turned on and the hand pump is removed from the end of the pressure testing tool, (o) The stop is opened, which allows gas to flow through the pressure testing tool, (p) With gas running, the pressure is monitored to determine if it is flowing at 5½″ w/c, (q) If this standard is not met, the regulator is adjusted, (r) Once the 5½″ w/c flow rate is achieved, the stop on the pressure testing tool is shut, (s) Monitor the gauge for lock-up which is the pressure when the gas is not flowing, i.e. showing 6″ w/c, and (t) If the flow, lock up and drag of meter are acceptable, the gas is turned off; (20) Remove the pressure testing tool; (21) Disconnect the nipple with 2 swivels; (22) Confirm that the swivel is loose to the meter on the outlet side; (23) Turn on the gas, (24) This procedure purges air from the meter and verifies that the meter is clocking, which means the dials are turning to signify gas is flowing through and being measured; and (25) This procedure takes a minimum of 25 minutes to complete.

The most common pressure test performed in an existing residential setting is a 10″ water column (w/c) test using a 1-A swivel meter set which consists of a meter and a regulator. One example of a 10 inch water column test performed on existing residential systems using an 1-A swivel with pressure test tools 28, 34, 36, 38 may include the following steps: (1) Shut off the gas; (2) Unscrew the 1-A swivel from both sides (inlet and outlet) of the meter, remove and set meter aside; (3) Attach the inches gauge to the pressure testing tool using a quick connect fitting; (4) Screw the outlet swivel to the pressure testing tool and tighten; (5) Pressurize the system by using the hand pump or other air source to reach a predetermined appropriate water column, for example without limitation, a 10″ water column (w/c); (6) Move the pressure testing tool stop to the “Off” position to lock the pressure at 10″ w/c; (7) Local regulations typically require the 10″ w/c to hold steady for a predetermined period of time; (8) If the needle on the pressure testing tool gauge does not move in the required time, the pressure test passes, but if the needle does move, it indicates a leak that must be located and fixed before proceeding; (9) Once the pressure test has been successfully completed, the pressure testing tool is removed from outlet side of the meter set; (10) Attach meter to inlet swivel; (11) To test the flow and lock-up of the regulator: (a) Using a nipple with a 1-A swivel attached to both ends, screw one end to the outlet side of the meter, (b) Attach the pressure testing tool into the opposite end of the nipple with swivels and tighten, (c) When the pressure testing tool is upside down, rotate the pressure gauge so it can be seen and read, (d) The gas is slowly turned on and the hand pump is removed from the end of the pressure testing tool, (e) The stop is opened, which allows gas to flow through the pressure testing tool; (f) With gas running, the pressure is monitored to determine if it is flowing at 5½″ w/c, (g) If this standard is not met, the regulator is adjusted, (h) Once the 5½″ w/c flow rate is achieved, the stop on the pressure testing tool is shut, (i) Monitor the gauge for lock-up which is the pressure when the gas is not flowing, hopefully showing 6″w/c, (j)

If the flow, lock up and drag of meter are acceptable, the gas is turned off [meter drag is when the meter is dropping pressure while the gas is flowing through it]; and (12) Remove the pressure testing tool. 13) Disconnect the nipple with 2 swivels; 14) Confirm that the swivel is loose to the meter on the outlet side; 15) Turn on the gas; 16) This procedure purges air from the meter and verifies that the meter is clocking which means the dials are turning to signify gas is flowing through and being measured; 17) Tighten both swivels to complete testing; 18) This procedure takes a minimum of 12 minutes to complete.

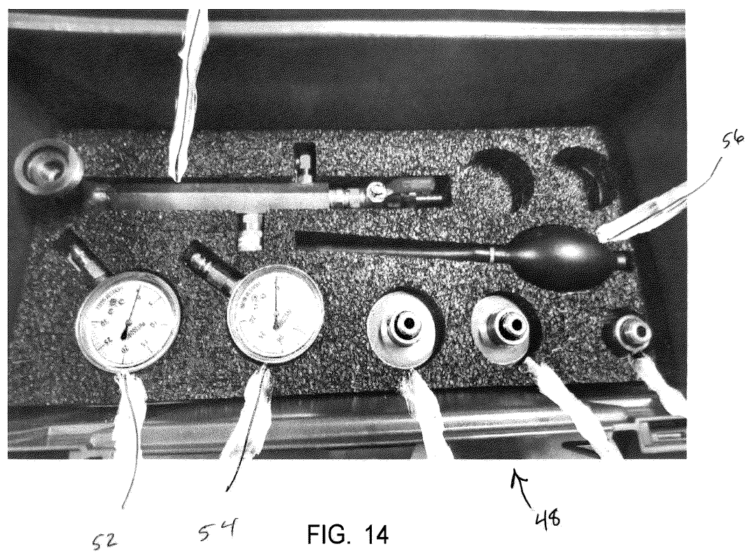

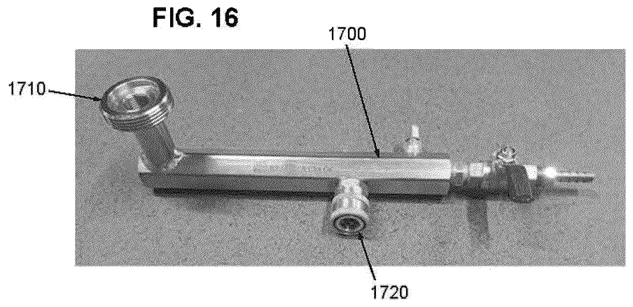

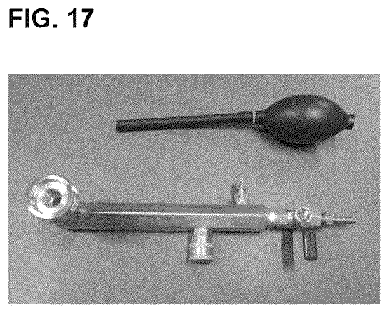

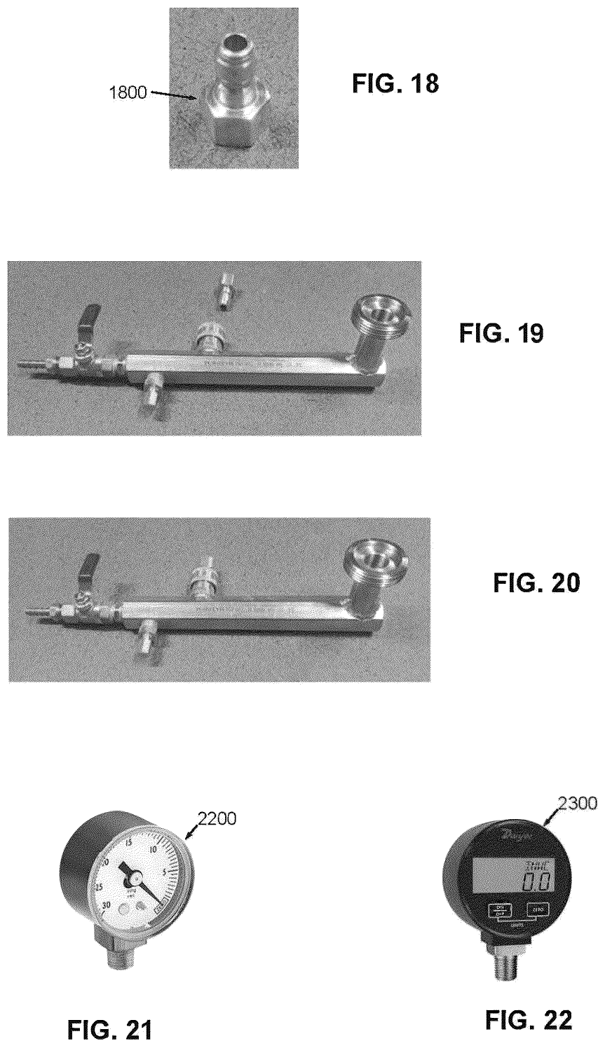

Testing tools 28, 34, 36, 38 may be included as part of a testing toolkit 48 as an innovative advancement in pressure testing equipment. The testing tools 28, 34, 36, 38 not only saves significant time, money, materials and space, it has the versatility to be utilized in multiple industries. Natural gas, propane and water systems may all take advantage of these cutting edge improvements in testing tool technology. One example of such a kit is shown in FIG. 14 and includes a testing tool body 50, pressure gauge (inches) 52, pressure gauge (pounds) 54, hand pump 56, an assortment of suitable flare pieces (e.g., ¼″, ⅜″, ½″, ⅝″, and the like) and an assortment of swivel adapters (10 lite, 20 lite, 30 lite, 45 lite, and the like) commonly used during testing procedures. Testing tool body 50 may in, in several embodiments, an integrally formed component that is nickel plated on both the exterior and interior surfaces to protect against rust and chemical corrosion. Any quick connect fittings used, for example without limitation, for attaching a pressure gauge, may be a solid brass (male) component. Embodiments with the nickel plating integrally formed body 1700 and the brass quick connect fitting 1800 are shown in FIGS. 16-20, with integral body 1700 with adapter 1710 and quick connect portion 1720 configured to sealingly connecting with fitting 1800. Suitable pressure gauges are shown in FIGS. 21 and 22, FIG. 21 showing pressure dial 2100 and FIG. 22 showing digital dial 2200.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed:

1. A tool having a monolithically integrated body for testing pressure within a gas supply system, the monolithically integrated body comprising:
a central cavity within the body,
a connection portion in fluid communication with the central cavity, the connection portion having a plurality of threaded sections for attaching to any one of a plurality of gas supply systems;
an inflation portal in fluid communication with the central cavity, the inflation portal configured for allowing pressurization through the body; and
a meter section in fluid communication with the central cavity, the meter section configured for measuring pressure within the body.

2. The tool of claim 1 wherein at least one of the threaded sections of the connection portion is disposed on an exterior surface of the monolithically integrated body.

3. The tool of claim 1 wherein at least one of the threaded sections of the connection portion is disposed on a concave surface of the monolithically integrated body.

4. The tool of claim 1 wherein the meter section is movable relative to the monolithically integrated body.

5. The tool of claim 1 wherein the meter section is rotatable about the monolithically integrated body.

6. A method of performing a pressure test on an existing residential a metered gas system using an integral pressure test tool having a monolithically integrated body with a central cavity, a connection portion having a plurality of threaded sections for attaching to any one of a plurality of gas supply systems, and an inflation portal, including the steps:
(1) shutting off the gas system;
(2) removing a meter of the gas system;
(3) attaching a gauge to the pressure test tool using a quick connect fitting;
(4) pressurizing the gas system to reach an appropriate water column;
(5) stopping the pressure testing tool to lock pressure at the appropriate water column;
(6) holding pressure steady for a predetermined period of time;
(7) monitoring the gauge to determine if a change in pressure is observed with a predetermined time;
(8) if a pressure change is observed, pausing the pressure test to fix leaks indicated by the pressure change;
(9) once the pressure test has been successfully completed, removing the pressure testing tool from outlet side of the meter set;
(10) attaching the meter to an inlet swivel of the pressure testing tool;
(11) testing flow and lock-up of the meter by: (a) screwing one end of the pressure testing tool to the outlet side of the meter, (b) attaching the pressure testing tool into the opposite end, (c) when the pressure testing tool is upside down, rotating the gauge to be visible, (d) slowly turning on the gas system, (e) opening the stop and allowing gas to flow through the pressure testing tool; (f) monitoring the pressure is monitored to determine if gas is flowing at a predetermined rate, (g) If the predetermined rate is not met, adjusting a regulator of the meter, (h) once the predetermined rate is achieved, shutting a stop on the pressure testing tool, (i) monitoring the gauge to determine if gas is not flowing and is at a predetermined pressure, (j) if determined that gas is not flowing and at a predetermined pressure, turning off the gas system; and
(12) removing the pressure testing tool;
(13) turning on the gas system to purge air from the meter and verifying that the meter is clocking;
(14) complete connection of the meter to the gas system and resume operation.
